(19) United States
(12) Patent Application Publication
(10) Pub. No.: US 2019/0135281 A1
(43) Pub. Date: May 9, 2019

(54) VEHICLE CONTROL DEVICE, VEHICLE CONTROL METHOD, AND RECORDING MEDIUM

(71) Applicant: HONDA MOTOR CO., LTD., Tokyo (JP)

(72) Inventors: Hiroshi Miura, Wako-shi (JP); Makoto Ishikawa, Wako-shi (JP); Masamitsu Tsuchiya, Wako-shi (JP); Koji Kawabe, Wako-shi (JP)

(21) Appl. No.: 16/172,983

(22) Filed: Oct. 29, 2018

(30) Foreign Application Priority Data
Nov. 8, 2017 (JP) 2017-215714

(51) Int. Cl. B60W 30/165; G05D 1/00; G06K 9/00; B60W 40/06; B60W 40/04

(52) U.S. Cl. CPC B60W 30/165; G05D 1/0088; G06K 9/00798; G05D 2201/0213; B60W 40/06; B60W 40/04; G06K 9/00805

(57) ABSTRACT

A vehicle control device includes: a first recognizer recognizing, in the vicinity of a first vehicle, a plurality of second vehicles; a second recognizer recognizing a road shoulder of a road on which the first vehicle is present; and a controller executing driving control of controlling one or both of steering and acceleration/deceleration of the first vehicle, wherein the controller sets a degree of monitoring of one of the plurality of second vehicles present on a road shoulder in a section from a branching point to a point a predetermined distance from the branching point, to be higher than another of the plurality of second vehicles present on a road shoulder out of the section.

### CROSS-REFERENCE TO RELATED APPLICATION

Priority is claimed on Japanese Patent Application No. 2017-215714, filed Nov. 8, 2017, the content of which is incorporated herein by reference.

### BACKGROUND OF THE INVENTION

### Field of the Invention

The present invention relates to a vehicle control device, a vehicle control method, and a storage medium.

### Description of Related Art

Conventionally, technologies for detecting a road shoulder having a space in which a vehicle can stop and controlling driving such that the vehicle stops on the detected road shoulder in a case in which disaster information is received have been disclosed (for example, see Japanese Unexamined Patent Application, First Publication No. 2010-20371).

### SUMMARY OF THE INVENTION

In conventional technologies, bringing a vehicle onto a road shoulder in the case of a non-emergency time has not been taken into consideration. However, there are cases in which, near an exit of an expressway or the like, a road shoulder may be congested due to vehicles traveling toward the exit, and a vehicle may not be able to smoothly enter the exit. In such cases, a situation may occur in which traveling of a following vehicle not traveling toward the exit may be limited, or a following vehicle may need to decelerate unintentionally.

An aspect of the present invention is realized in consideration of such situations, and one object thereof is to provide a vehicle control device, a vehicle control method, and a storage medium capable of executing driving control with a status of a road shoulder taken into account.

A vehicle control device, a vehicle control method, and a storage medium according to the present invention employ the following configurations.

(1): According to one aspect of the present invention, there is provided a vehicle control device including: a first recognizer recognizing, in the vicinity of a first vehicle, a plurality of second vehicles; a second recognizer recognizing a road shoulder of a road on which the first vehicle is present; and a controller executing driving control of controlling one or both of steering and acceleration/deceleration of the first vehicle, wherein the controller sets a degree of monitoring of one of the plurality of second vehicles present on a road shoulder in a section from a branching point to a point a predetermined distance from the branching point, to be higher than another of the plurality of second vehicles present on a road shoulder out of the section.

(2): In the aspect (1) described above, in a case in which the plurality of second vehicles are aligned in an advancement direction of the first vehicle on the road shoulder, the controller executes control of causing the first vehicle to follow one of the plurality of second vehicles aligned on the road shoulder.

(3): In the aspect (2) described above, the controller executes control of causing the first vehicle to follow a rearmost vehicle among the plurality of second vehicles aligned on the road shoulder.

(4): In the aspect (1) described above, in a case in which the plurality of second vehicles are aligned in an advancement direction of the first vehicle on the road shoulder, the controller executes control of operating a direction indicator at a timing earlier than that in a case in which the plurality of second vehicles are not aligned in the advancement direction of the first vehicle on the road shoulder.

(5): In the aspect (2) described above, the controller determines a state of a first one of the plurality of second vehicles present on a road shoulder on the basis of a speed, executes the control in a case in which the state of the first one of the plurality of second vehicles are a moving state, and does not execute the control in a case in which the state of the first one of the plurality of second vehicles are a stopped state.

(6): According to one aspect of the present invention, there is provided a vehicle control method executed by an in-vehicle computer mounted in a vehicle. The vehicle control method using the in-vehicle computer includes: recognizing, in the vicinity of a first vehicle, a plurality of second vehicles; recognizing a road shoulder of a road on which the first vehicle is present; executing driving control of controlling one or both of steering and acceleration/deceleration of the first vehicle; and setting a degree of monitoring of one of the plurality of second vehicles present on a road shoulder in a section from a branching point to a point a predetermined distance from the branching point, to be higher than another of the plurality of second vehicles present on a road shoulder out of the section.

(7): According to one aspect of the present invention, there is provided a computer-readable non-transitory storage medium having a program stored thereon, the program causing an in-vehicle computer to execute: a process of recognizing, in the vicinity of a first vehicle, a plurality of second vehicles; a process of recognizing a road shoulder of a road on which the first vehicle is present; a process of executing driving control of controlling one or both of steering and acceleration/deceleration of the first vehicle; and a process of setting a degree of monitoring of one of the plurality of second vehicles present on a road shoulder in a section from a branching point to a point a predetermined distance from the branching point, to be higher than another of the plurality of second vehicles present on a road shoulder out of the section.

According to the aspects (1) to (7) described above, driving control can be executed with the status of a road shoulder taken into account.

### BRIEF DESCRIPTION OF THE DRAWINGS

FIG. 1 is a configuration diagram of a vehicle system using a vehicle control device according to an embodiment;

FIG. 2 is a functional configuration diagram of a first controller and a second controller;

FIG. 3 is a diagram illustrating a view in which a target locus is generated on the basis of a recommended lane;

FIG. 4 is a flowchart illustrating one example of the flow of a process executed by a branching controller according to a first embodiment;

FIG. 5 is a diagram illustrating an example of running of a subject vehicle in a case in which there is no other vehicle on a road shoulder;

FIG. 6 is a diagram illustrating an example of running of a subject vehicle in a case in which there is another vehicle on a road shoulder;

FIG. 7 is a flowchart illustrating one example of the flow of a process executed by a branching controller according to a second embodiment;

FIG. 8 is a diagram illustrating another example of running of a subject vehicle in a case in which there is a preceding vehicle on a road shoulder;

FIG. 9 is a configuration diagram of another vehicle system using a vehicle control device according to an embodiment; and

FIG. 10 is a diagram illustrating one example of the hardware configuration of a vehicle control device according to an embodiment.

### DETAILED DESCRIPTION OF THE INVENTION

### First Embodiment

Hereinafter, a vehicle control device, a vehicle control method, and a storage medium according to embodiments of the present invention will be described with reference to the drawings. Hereinafter, although a case in which a rule of left-side traffic is applied will be described, the left side and the right side may be interchanged in a case in which a rule of right-side traffic is applied.

### [Entire Configuration]

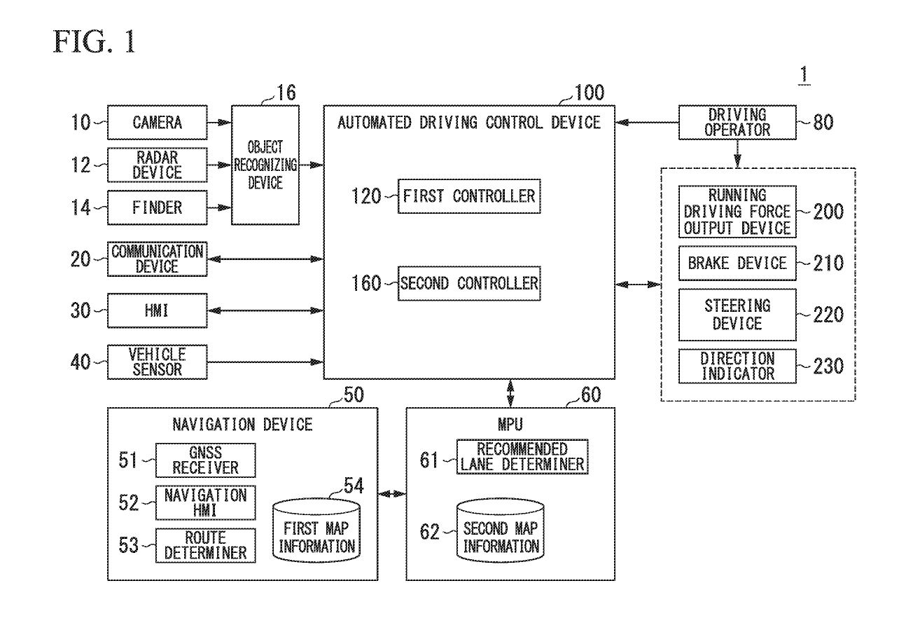

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. In a case in which an electric motor is included, the electric motor operates using power generated using a power generator connected to an internal combustion engine or discharge power of a secondary cell or a fuel cell.

The vehicle system 1, for example, includes a camera 10, a radar device 12, a finder 14, an object recognizing device 16, a communication device 20, a human machine interface (HMI) 30, a vehicle sensor 40, a navigation device 50, a map positioning unit (MPU) 60, a driving operator 80, an automated driving control device 100, a running driving force output device 200, a brake device 210, a steering device 220, and a direction indicator 230. Such devices and units are interconnected using a multiplex communication line such as a controller area network (CAN) communication line, a serial communication line, a radio communication network, or the like. The configuration illustrated in FIG. 1 is merely one example, and thus, a part of the configuration may be omitted, and, furthermore, other components may be added thereto.

The camera 10, for example, is a digital camera using a solid-state imaging device such as a charge coupled device (CCD) or a complementary metal oxide semiconductor (CMOS). One or a plurality of cameras 10 are installed at arbitrary places on a vehicle (hereinafter, referred to as a subject vehicle M) in which the vehicle system 1 is mounted. In a case in which the side in front is to be imaged, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radiowaves such as millimeter waves to the vicinity of the subject vehicle M and detects at least a position of (a distance and an azimuth to) an object by detecting radiowaves (reflected waves) reflected by the object. One or a plurality of radar devices 12 are installed at arbitrary places on the subject vehicle M. The radar device 12 may detect a position and a speed of an object using a frequency modulated continuous wave (FM-CW) system.

The finder 14 is a light detection and ranging (LIDAR) device. The finder 14 emits light to the vicinity of the subject vehicle M and measures scattering light. The finder 14 detects a distance to a target on the basis of a time from light emission to light reception. The emitted light, for example, is a pulse-form laser light. One or a plurality of finders 14 are mounted at arbitrary positions on the subject vehicle M.

The object recognizing device 16 may perform a sensor fusion process on results of detection using some or all of the camera 10, the radar device 12, and the finder 14, thereby allowing recognition of a position, a type, a speed, and the like of an object. The object recognizing device 16 outputs a result of recognition to the automated driving control device 100. The object recognizing device 16, as is necessary, may output results of detection using the camera 10, the radar device 12, and the finder 14 to the automated driving control device 100 as they are. The object recognizing device 16 is one example of a speed acquiring unit that acquires speeds of other vehicles running in an adjacent lane. The speed acquiring unit may include the radar device 12.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various types of information to an occupant of the subject vehicle M and receives an input operation performed by a vehicle occupant. The HMI 30 may include various display devices, a speaker, a buzzer, a touch panel, switches, keys, and the like.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 50, for example, includes a global navigation satellite system (GNSS) receiver 51, a navigation HMI 52, and a route determiner 53 and stores first map information 54 in a storage such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The route determiner 53, for example, determines a route to a destination input by a vehicle occupant using the navigation HMI 52 (hereinafter, referred to as a route on a map) from a position of the subject vehicle M identified by the GNSS receiver 51 (or an input arbitrary position) by referring to the first map information 54. The first map information 54, for example, is information in which a road form is represented by respective links representing a road and respective nodes connected using the links. The first map information 54 may include a curvature of each road, point of interest (POI) information, and the like. The route on the map determined by the route determiner 53 is output to the MPU 60. In addition, the navigation device 50 may perform route guidance using the navigation HMI 52 on the basis of the route on the map determined by the route determiner 53. The navigation device 50, for example, may be realized by a function of a terminal device such as a smartphone or a tablet terminal held by a vehicle occupant. In addition, the navigation device 50 may transmit a current location and a destination to a navigation server through the communication device 20 and acquire a route on the map received from the navigation server as a reply.

The MPU 60, for example, functions as a recommended lane determiner 61 and stores second map information 62 in a storage such as an HDD or a flash memory. The recommended lane determiner 61 divides a route provided from the navigation device 50 into a plurality of blocks (for example, divides the route into blocks of 100 [m] in the advancement direction of the vehicle) and determines a recommended lane for each block by referring to the second map information 62. The recommended lane determiner 61 determines on which of lanes numbered from the left side to run. In a case in which a branching place, a merging place, or the like is present in the route, the recommended lane determiner 61 determines a recommended lane such that the subject vehicle M can run on a reasonable route for advancement to divergent destinations.

The second map information 62 is map information having an accuracy higher than that of the first map information 54. The second map information 62, for example, includes information of the center of respective lanes, information on boundaries between lanes, or the like. In addition, in the second map information 62, road information, traffic regulations information, address information (address and zip code), facilities information, telephone number information, and the like may be included. By accessing another device using the communication device 20, the second map information 62 may be updated as needed.

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to the automated driving control device 100 or at least one or all of the running driving force output device 200, the brake device 210, and the steering device 220.

The automated driving control device 100, for example, includes a first controller 120, and a second controller 160. Each of the first controller 120 and second controller 160, for example, is realized by a hardware processor such as a central processing unit (CPU) executing a program (software). In addition, some or all of such constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by cooperation between software and hardware. The program may be stored in a storage such as a hard disk drive (HDD) or a flash memory or may be stored in a storage medium such as a DVD or a CD-ROM that can be loaded or unloaded and installed in a storage by loading the storage medium into a drive device.

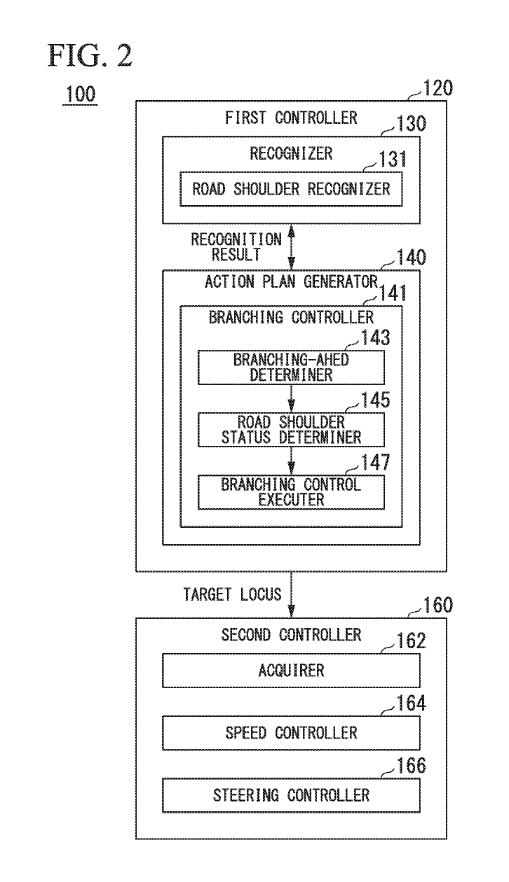

FIG. 2 is a functional configuration diagram of the first controller 120 and the second controller 160. The first controller 120, for example, includes a recognizer 130 and an action plan generator 140. The first controller 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a signal, road markings, and the like that can be used for pattern matching are present) at the same time and comprehensively evaluating both the recognitions by assigning scores to them. Accordingly, the reliability of automated driving is secured.

The action plan generator 140 includes a branching controller 141. The branching controller 141 includes a branching-ahead determiner 143, a road shoulder status determiner 145, and a branching control executer 147. The functions of these will be described later, and, first, the basic functions of the recognizer 130 and the action plan generator 140 will be described.

The recognizer 130 recognizes states such as a position, a speed, an acceleration, and the like of each object present in the vicinity of the subject vehicle M on the basis of information input from the camera 10, the radar device 12, and the finder 14 through the object recognizing device 16. The position of an object, for example, is recognized as a position on an absolute coordinate system having a representative point (the center of gravity, the center of a driving shaft, or the like) of the subject vehicle M as its origin and is used for control. The position of an object may be represented as a representative point such as the center of gravity or a corner of an object or may be represented in a represented area. A “state” of an object may include an acceleration, a jerk, or an “action state” (for example, whether or not the object is changing lanes or to change lanes) of an object. In addition, the recognizer 130 recognizes the shape of a curve along which the subject vehicle M will pass subsequently on the basis of a captured image captured by the camera 10. The recognizer 130 converts the shape of the curve from the captured image captured by the camera 10 into an actual plane and, for example, outputs two-dimensional point sequence information or information represented using a model equivalent thereto to the action plan generator 140 as information representing the shape of the curve.

The recognizer 130, for example, recognizes a lane (running lane) in which the subject vehicle M is running. A result of the recognition of a lane, for example, represents a lane in which the subject vehicle M is running among a plurality of lanes in the same advancement direction. In the case of one lane, an indication thereof may be a result of the recognition. For example, the recognizer 130 may recognize a running lane by comparing a pattern of road partition lines acquired from the second map information 62 (for example, an array of solid lines and broken lines) with a pattern of road partition lines in the vicinity of the subject vehicle M that has been recognized from an image captured by the camera 10. The recognizer 130 is not limited to recognizing road partition lines and may recognize a running lane by recognizing running lane boundaries (road boundaries) including a road partition line, a road shoulder, curbstones, a median strip, a guardrail, and the like. In the recognition, the position of the subject vehicle M acquired from the navigation device 50 or a result of the process executed by an INS may be additionally taken into account. In addition, the recognizer 130 may recognize a temporary stop line, an obstacle object, a red light, a tollgate, and other road events.

When a running lane is recognized, the recognizer 130 recognizes a position and a posture of the subject vehicle M with respect to the running lane. The recognizer 130, for example, may recognize a deviation of a reference point on the subject vehicle M from the center of the lane and an angle of the advancement direction of the subject vehicle M formed with respect to a line along the center of the lane as a relative position and a posture of the subject vehicle M with respect to the running lane. Instead of this, the recognizer 130 may recognize a position of a reference point on the subject vehicle M with respect to a one side end part (a road partition line or a road boundary) of the running lane or the like as a relative position of the subject vehicle M with respect to the running lane.

The recognizer 130 includes a road shoulder recognizer 131. The road shoulder recognizer 131 recognizes a road shoulder of a road on which the subject vehicle M is present on the basis of an image captured by the camera 10 and outputs a result of the recognition to the branching controller 141. For example, the road shoulder recognizer 131 may recognize one or both of an area outside (left) a road partition line positioned on the leftmost side and an area outside (right) a road partition line positioned on the rightmost side among road partition lines recognized by the recognizer 130 as road shoulders. The road shoulder recognizer 131 may recognize an end part of the road shoulder and recognize an area disposed between the recognized end part and a road partition line as a road shoulder. For example, the road shoulder recognizer 131 may recognize a boundary line with a protective wall, a change in a road material, a level difference, or the like as an end part of the road shoulder. The road shoulder recognizer 131 may recognize an area between the recognized end part of the road shoulder and an outermost lane partition line as a road shoulder. There are cases in which a width of a road shoulder is defined for each road. In such a case, the road shoulder recognizer 131 may recognize an area in a range determined in accordance with the width from a road partition line as a road shoulder.

In the recognition process described above, the recognizer 130 derives a recognition accuracy and outputs the derived recognition accuracy to the action plan generator 140 as recognition accuracy information. For example, the recognizer 130 generates recognition accuracy information on the basis of a frequency at which a road partition line is recognized over a predetermined time period.

The action plan generator 140 determines events to be sequentially executed in automated driving such that the subject vehicle basically runs on a recommended lane determined by the recommended lane determiner 61 and can respond to a surroundings status of the subject vehicle M. As the events, for example, there are a constant-speed running event for running at a constant speed in the same running lane, a following running event of following a vehicle running ahead, an overtaking event of overtaking a vehicle running ahead, an avoidance event of performing braking and/or steering for avoiding approaching an obstacle object, a curved running event of running on a curve, a passing through event for passing through a predetermined point such as an intersection, a pedestrian crossing, a railroad crossing, or the like, a lane change event, a merging event, a branching event, an automated stopping event, a takeover event for ending automated driving and switching to manual driving, and the like.

The action plan generator 140 generates a target locus along which the subject vehicle M will run in the future in accordance with operating events. Details of each functional unit will be described later. The target locus, for example, includes a speed element. For example, the target locus is represented by sequentially aligning places (locus points) at which the subject vehicle M will arrive. A locus point is a place at which the subject vehicle M will arrive at respective predetermined running distances (for example, about every several [m]) as distances along the road, and separately, a target speed and a target acceleration for each of predetermined sampling times (for example, a fraction of a [sec]) are generated as a part of the target locus. A locus point may be a position at which the subject vehicle M will arrive at a sampling time for each predetermined sampling time. In such a case, information of a target speed or a target acceleration is represented using intervals between the locus points.

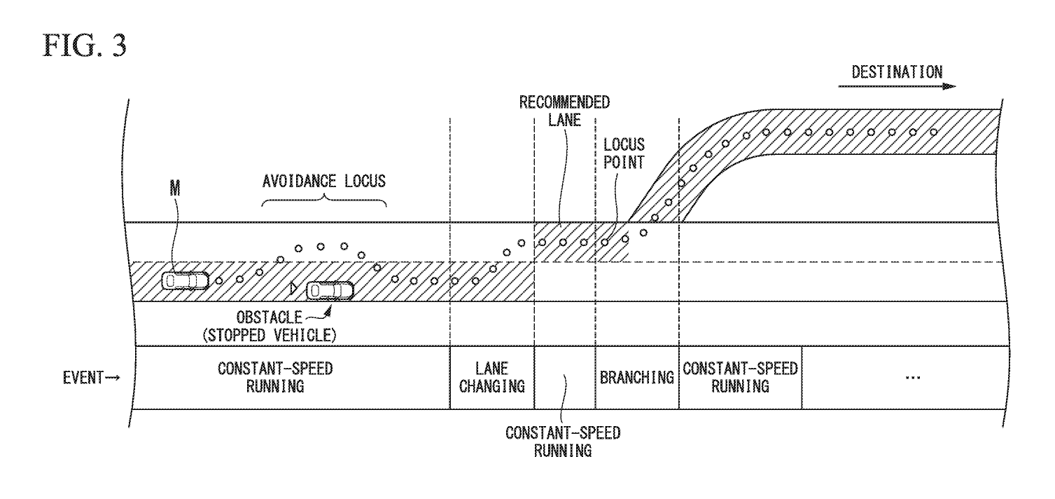

FIG. 3 is a diagram illustrating a view in which a target locus is generated on the basis of recommended lanes. As illustrated in the drawing, the recommended lanes are set such that surroundings are convenient for running along a route to a destination.

When reaching a predetermined distance (may be determined in accordance with a type of event) before a place at which a recommended lane is changed, the action plan generator 140 executes the passing through event, the lane change event, the branching event, the merging event, or the like. During execution of each event, in a case in which there is a need to avoid an obstacle object, an avoidance locus is generated as illustrated in the drawing.

The second controller 160 performs control of the running driving force output device 200, the brake device 210, and the steering device 220 such that the subject vehicle M passes along a target locus generated by the action plan generator 140 at a scheduled time.

Referring back to FIG. 2, the second controller 160, for example, includes an acquirer 162, a speed controller 164, and a steering controller 166. The acquirer 162 acquires information of a target locus (locus points) generated by the action plan generator 140 and stores the target locus information in a memory (not illustrated). The speed controller 164 controls the running driving force output device 200 or the brake device 210 on the basis of a speed element accompanying the target locus stored in the memory. The steering controller 166 controls the steering device 220 in accordance with a degree of curvature of the target locus stored in the memory. The processes of the speed controller 164 and the steering controller 166, for example, are realized by a combination of feed forward control and feedback control. For example, the steering controller 166 may execute feed forward control according to the curvature of a road in front of the subject vehicle M and feedback control based on a deviation from the target locus in combination.

The running driving force output device 200 outputs a running driving force (torque) used for a vehicle to run to driving wheels. The running driving force output device 200, for example, includes a combination of an internal combustion engine, an electric motor, a transmission, and the like and an ECU controlling these components. The ECU controls the components described above in accordance with information input from the second controller 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second controller 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second controller 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second controller 160 or information input from the driving operator 80.

The direction indicator 230 is disposed along the side faces of the vehicle and includes a left direction indicator and a right direction indicator. The direction indicator 230 is switched on and off in accordance with information input from the second controller 160 or information input from the driving operator 80.

Next, the branching controller 141 included in the action plan generator 140 will be described in detail.

While the subject vehicle M is running within a branching-ahead section, the branching controller 141 executes branching-time driving control in consideration of other vehicles present on a road shoulder (hereinafter, referred to as branching control). Here, the branching-ahead section, for example, is a section from a branching point on a route of the subject vehicle M to a position that is a predetermined distance before the branching point. Here, a branching point on the track of the subject vehicle M is a branching point appearing on a track in which the subject vehicle M is scheduled to run and, for example, a branching point for entering an exit, a parking area, or a service area from the main route of an expressway. A branching point on the track of the subject vehicle M, for example, is perceived on the basis of a relation between a route generated by the navigation device 50 and a map.

In branching control, the branching controller 141 monitors other vehicles m present on a road shoulder recognized by the road shoulder recognizer 131 and executes driving control based on the states of the other vehicles m present on the road shoulder. This driving control will be described in detail later. On the other hand, in a case in which the subject vehicle M is not running in the branching-ahead section, the branching controller 141 does not execute the branching control. For this reason, in a case in which the subject vehicle M is not running within the branching-ahead section, the action plan generator 140 basically does not execute driving control based on other vehicles present on a road shoulder. In other words, the branching controller 141 sets a degree of monitoring of one of a plurality of second vehicles present on a road shoulder in a section from a branching point to a point a predetermined distance from the branching point, to be higher than another of the plurality of second vehicles present on a road shoulder out of the section. The second vehicles are recognized by the recognizer 130 in the vicinity of a subject vehicle. The function of each component included in the branching controller 141 will be described with reference to flowchart to be described below.

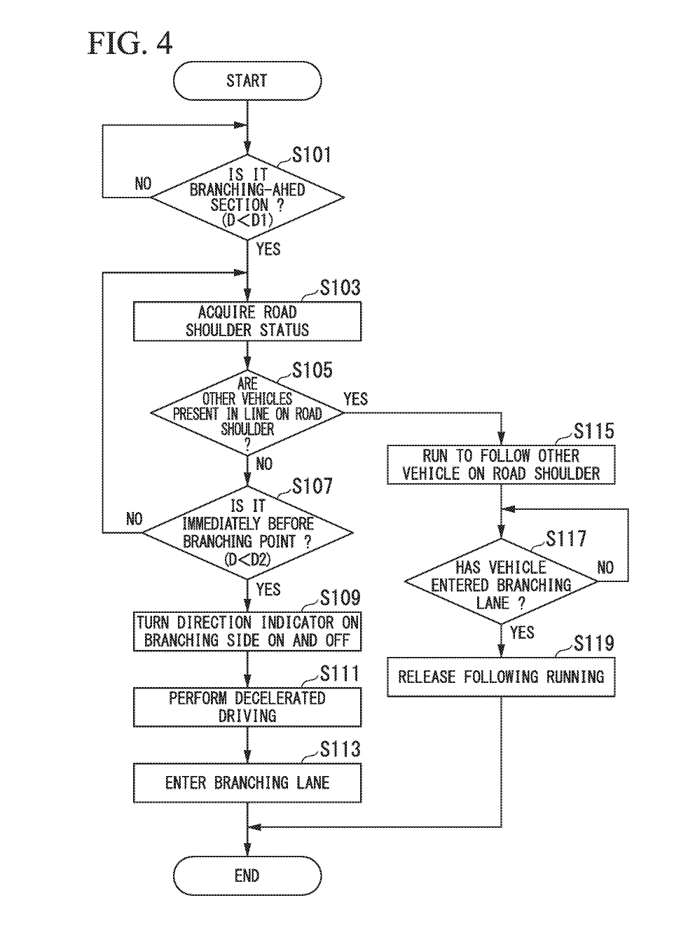

Next, an example of a process according to this embodiment will be described with reference to FIG. 4. FIG. 4 is a flowchart illustrating one example of the flow of a process executed by the branching controller 141 according to a first embodiment.

First, the branching-ahead determiner 143 determines whether or not the subject vehicle M has entered a branching-ahead section (Step S101). For example, the branching-ahead determiner 143 determines whether or not a distance D from the current position of the subject vehicle M to a branching point Pb on the map is equal to or less than a first threshold D1 determined in advance. The branching point Pb is a branching point on the track of the subject vehicle M. For example, the first threshold D1, for example, is a distance of about 2 [km]. Instead of the determination of Step S101, it may be determined “whether or not the subject vehicle M has passed an exit previous to an exit at which the subject vehicle is planned to depart from the expressway”. In a case in which it is determined that the subject vehicle M has not entered a branching-ahead section, the branching-ahead determiner 143 repeats the process of Step S101 until “Yes” is determined.

On the other hand, in a case in which it is determined that the subject vehicle M has entered the branching-ahead section by the branching-ahead determiner 143 in Step S101, the road shoulder status determiner 145 acquires a road shoulder status on the basis of a result of the recognition using the recognizer 130 and a result of the recognition using the road shoulder recognizer 131 (Step S103). In the road shoulder status, for example, presence/absence, speeds, and the like of other vehicles m on a road shoulder are included. For example, the road shoulder status determiner 145 may acquire a status of other vehicles m present on the road shoulder recognized by the road shoulder recognizer 131 among other vehicles m recognized by the recognizer 130 as a road shoulder status.

The road shoulder status determiner 145 determines whether or not a plurality of other vehicles m are running in line on the road shoulder on the basis of the acquired road shoulder status (Step S105). In a case in which “No” is determined in Step S105, the branching-ahead determiner 143 determines whether or not the subject vehicle M is running immediately before the branching point Pb (Step S107). For example, the branching-ahead determiner 143 may determine whether or not a distance D from the current position of the subject vehicle M to the branching point Pb is equal to or less than a second threshold D2 that is determined in advance. For example, the second threshold D2 may be a distance that is necessary for lane change to a branching lane at the branching point Pb. In a case in which it is determined that the subject vehicle M is not running immediately before the branching point Pb in Step S107, the branching-ahead determiner 143 returns to the process of Step S103 and repeats the process until “Yes” is acquired in Step S107.

On the other hand, in a case in which it is determined by the branching-ahead determiner 143 that the subject vehicle M is running immediately before the branching point Pb in Step S107, the branching control executer 147 controls the direction indicator 230 such that the direction indicator 230 on the branching side is turned on and off (Step S109). Next, the branching control executer 147 instructs the speed controller 164 to decelerate the subject vehicle M (Step S111). Then, the branching control executer 147 generates a target locus for entering a lane of a branching destination and outputs the generated target locus to the second controller 160 (Step S113).

On the other hand, in Step S105, in a case in which it is determined by the road shoulder status determiner 145 that a plurality of other vehicles m are running in line on the road shoulder, the branching control executer 147 generates a target locus for moving to the road shoulder and being directed toward a rearmost vehicle m (or another vehicle m in a positional relationship easiest for following) among the plurality of other vehicles m at a time point at which the plurality of other vehicles m present on the road shoulder are recognized and outputs the generated target locus to the second controller 160. The branching control executer 147 controls the second controller 160 such that the subject vehicle M runs to follow the other vehicle m that is a preceding vehicle of the subject vehicle M (Step S115). Before Step S115, the branching control executer 147 may control the direction indicator 230 such that the direction indicator 230 disposed on a branching side is turned on and off. The other vehicle m running on the road shoulder connected to a branching lane L4 is estimated to enter the branching lane L4 soon. Accordingly, the subject vehicle M performs following running as described above and thus can enter the branching lane L4 at the branching point Pb naturally. Next, the branching control executer 147 determines whether or not the subject vehicle M has entered the branching lane (Step S117). Then, in a case in which it is determined that the subject vehicle M has entered the branching lane, the branching control executer 147 terminates following running (Step S119).

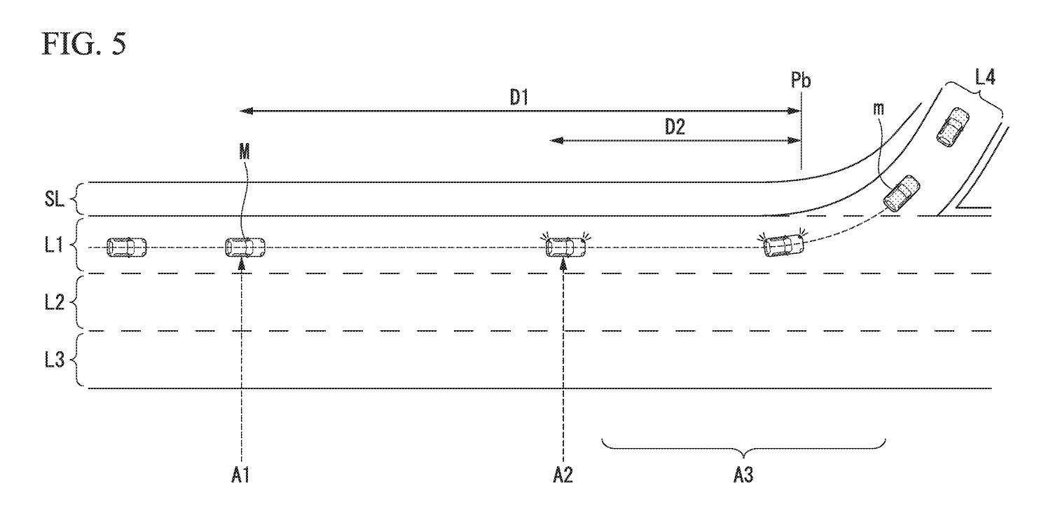

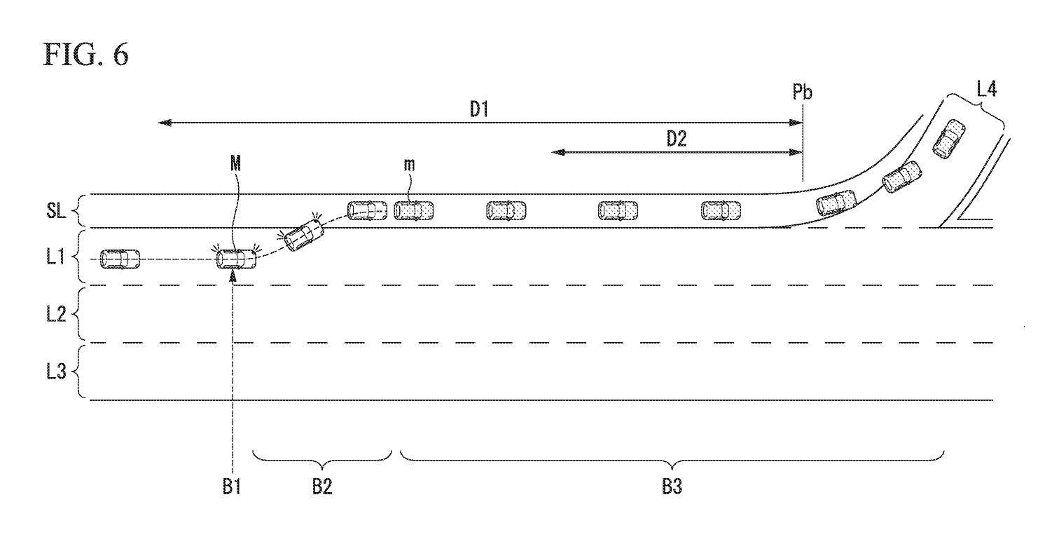

Next, an example of running of a vehicle in a case in which the vehicle control device according to this embodiment is used will be described with reference to FIGS. 5 and 6. FIG. 5 is a diagram illustrating an example of running of a subject vehicle M in a case in which there are no preceding vehicle on a road shoulder. FIG. 6 is a diagram illustrating an example of running of a subject vehicle M in a case in which there is a preceding vehicle on a road shoulder. A road illustrated in FIGS. 5 and 6 is a road of three lanes on each side and includes the lanes L1 to L3. A road shoulder SL is adjacent to the left side of the lane L1, and a branching lane L4 extends from the branching point Pb. The subject vehicle M is running in the leftmost lane L1.

Next, FIG. 5 will be described. In a case in which the branching point Pb is present on the route of the subject vehicle M, when the distance D to the branching point Pb is equal to or less than the first threshold D1, the road shoulder status determiner 145 starts to acquire a road status (a point A1). In the example, since no other vehicle m is present on the road shoulder SL, the subject vehicle M continues to run in the lane L1. Then, when the distance D from the branching point Pb becomes equal to or less than the second threshold D2, the branching control executer 147 controls the direction indicator 230 such that the direction indicator 230 disposed on the branching side is turned on and off (a point A2). Accordingly, the subject vehicle M turns the left direction indicator 230 on and off. Thereafter, the branching control executer 147 changes lane to the branching lane L4 while decelerating the subject vehicle M (a section A3). Accordingly, the subject vehicle M enters the branching lane L4 while decelerating.

In the example illustrated in FIG. 6, the road shoulder status determiner 145 determines that a plurality of other vehicles m are running in line on the road shoulder SL on the basis of the acquired road shoulder status. In this case, the branching control executer 147 moves the subject vehicle M to the road shoulder SL while decelerating it and causes the subject vehicle to follow one of the other vehicles m running on the road shoulder (a section B2). Before this, the branching control executer 147 may control the direction indicator 230 such that the direction indicator 230 disposed on the branching side is turned on and off (a point B1). Then, the subject vehicle M runs to follow one of the plurality of other vehicles m aligned on the road shoulder SL and enters the branching lane L4 from the branching point Pb (a section B3).

According to the vehicle control device of the first embodiment described above, in a case in which a plurality of other vehicles recognized by the recognizer 130 are aligned in the advancement direction of the subject vehicle on the road shoulder recognized by the road shoulder recognizer 131, the branching controller 141 executes control causing the subject vehicle to follow one of the plurality of other vehicles aligned on the road shoulder, and accordingly, even in a case in which the road shoulder is congested with other vehicles m directed toward a branching lane, the subject vehicle can smoothly advance to the branching lane. Thus, the subject vehicle M not joining a row of other vehicles following the branching lane and passing a branching point can be avoided.

### Second Embodiment

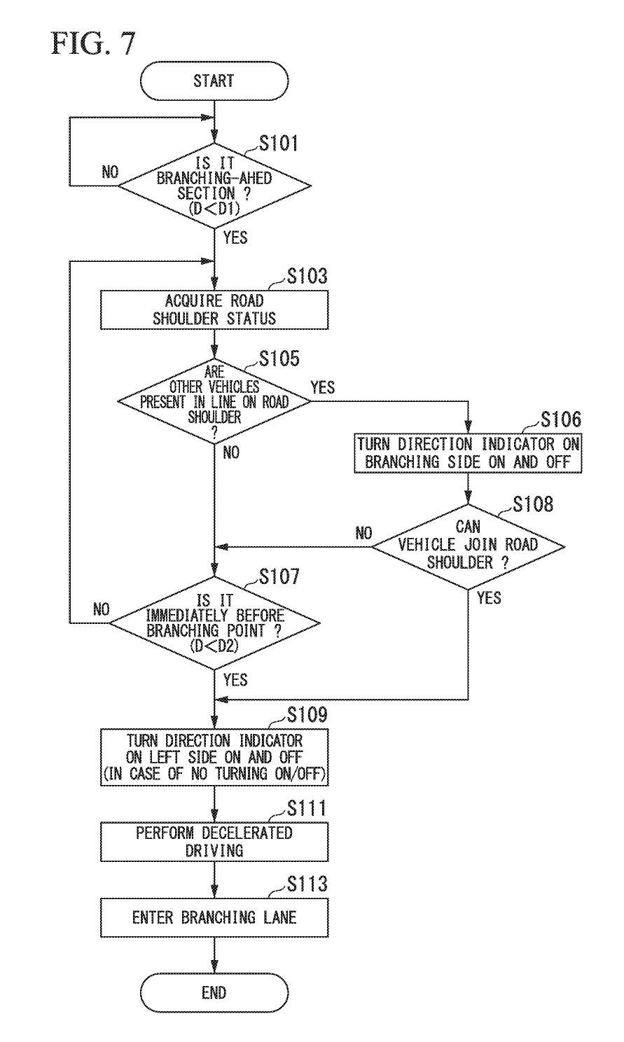

Hereinafter, a second embodiment will be described. As the configuration diagrams, FIGS. 1 and 2 will be cited. Hereinafter, points different from the first embodiment will be described in detail with reference to FIG. 7. FIG. 7 is a flowchart illustrating an example of a process according to a second embodiment. The same reference sign will be assigned to each process that is the same as that illustrated in FIG. 4, and description thereof will not be presented here.

Steps S101 and S103 are similar to those of the flowchart illustrated in FIG. 4, and thus description thereof will not be presented. In a case in which it is determined by a road shoulder status determiner 145 that a plurality of other vehicles m are not running in line on a road shoulder in Step S105, and in a case in which it is determined that a subject vehicle M is immediately before a branching point Pb in Step S107, a branching control executer 147 controls a direction indicator 230 such that a direction indicator 230 disposed on a branching side is turned on and off (Step S109). Next, the branching control executer 147 instructs a speed controller 164 to decelerate the subject vehicle M (Step S111). Then, the branching control executer 147 generates a target locus for entering a branching lane and outputs the generated target locus to a second controller 160 (Step S113).

On the other hand, in a case in which it is determined by the road shoulder status determiner 145 that a plurality of other vehicles m are running in line on a road shoulder in Step S105, the branching control executer 147 controls the direction indicator 230 such that a direction indicator 230 disposed on the branching side is turned on and off at the time point (Step S106). Thereafter, the road shoulder status determiner 145 determines whether or not the subject vehicle can join the row of the plurality of other vehicles m running on the road shoulder on the basis of the acquired road shoulder status (Step S108). For example, the road shoulder status determiner 145 derives at least one index value such as an inter-vehicle distance or a time to collision (TTC) between other vehicles m present on the road shoulder and determines whether or not the subject vehicle can enter between the other vehicles m on the basis of the derived index value. In a case in which it is determined that the subject vehicle can join the row of the plurality of other vehicles m present on the road shoulder in Step S108, the branching control executer 147 instructs the speed controller 164 to decelerate the subject vehicle M (Step S111), generates a target locus for entering between the other vehicles m, and outputs the generated target locus to the second controller 160. The branching control executer 147 controls the second controller 160 such that the subject vehicle runs to follow a preceding vehicle m of the subject vehicle M (Step S113).

On the other hand, in a case in which it is determined that the subject vehicle cannot join the row of the plurality of other vehicles m present on the road shoulder using the road shoulder status determiner 145 in Step S108, a branching-ahead determiner 143 determines whether or not the subject vehicle M is immediately before the branching point Pb (Step S107). In a case in which “No” is determined in Step S107, the process is returned to Step S103, and the process is repeated until “Yes” is determined in Step S107. On the other hand, in a case in which it is determined that the subject vehicle M is immediately before the branching point Pb in Step S107, the branching control executer 147 instructs the speed controller 164 to decelerate the subject vehicle M (Step S111). A target locus for entering a branching lane L4 is generated, and the generated target locus is output to the second controller 160. Then, the branching control executer 147 controls the second controller 160 such that the subject vehicle runs to follow the other vehicle m preceding the subject vehicle M (Step S113). In a case in which the subject vehicle cannot enter the branching lane L4 due to the presence of the other vehicle m at the branching point Pb, the branching control executer 147 waits for a timing at which the subject vehicle can join between the other vehicles m entering the branching lane L4 and causes the subject vehicle M to enter the branching lane L4.

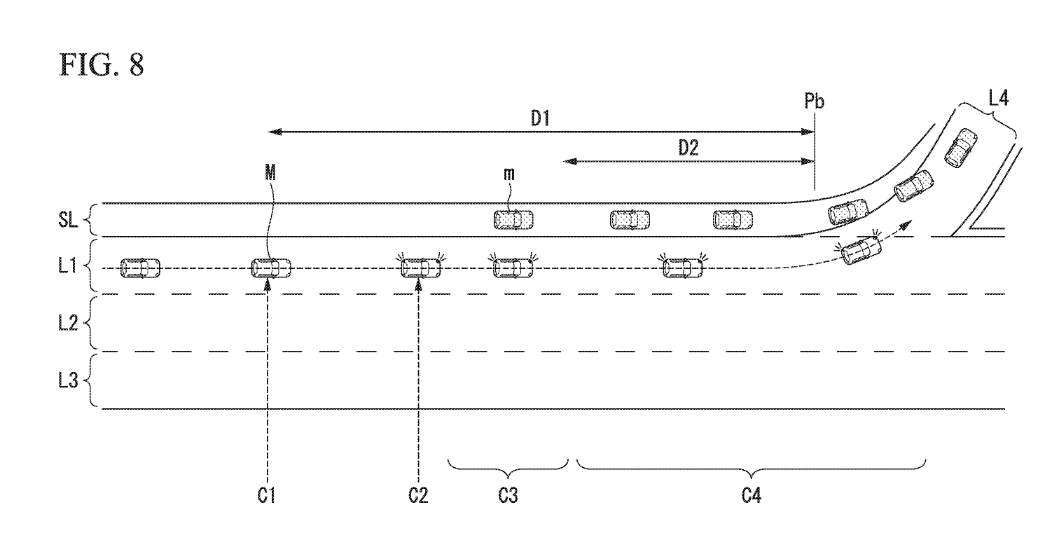

Next, an example of running of a vehicle in a case in which the vehicle control device according to this embodiment is used will be described with reference to FIG. 8. FIG. 8 is a diagram illustrating an example of running of a subject vehicle M in a case in which there is a preceding vehicle on a road shoulder. A road on which the subject vehicle M runs is the same as the road illustrated in FIGS. 5 and 6.

In a case in which there is a branching point Pb on a route of the subject vehicle M, the road shoulder status determiner 145 starts to acquire a road shoulder status at a time point at which a distance D up to the branching point Pb is equal to or less than a first threshold D1 (a point C1). In the example illustrated in the drawing, any other vehicle m present on the road shoulder SL is not recognized at this time point, and accordingly, the subject vehicle M continues to run the lane L1. Thereafter, it is assumed that the road shoulder status determiner 145 determines that a plurality of other vehicles m are running in line on the road shoulder SL. In this case, the branching control executer 147 controls the direction indicator 230 such that the direction indicator 230 disposed on the branching side is turned on and off at a time point at which it is determined that the plurality of other vehicles m are running in line on the road shoulder SL (a point C2).

Accordingly, the subject vehicle M turns the left direction indicator 230 on and off. Then, the subject vehicle M runs in a lane L1 while continuously turning the direction indicator 230 disposed on the branching side on and off (a section C3). In this section C3, in a case in which the subject vehicle can join the row of the plurality of other vehicles m present on the road shoulder, the branching control executer 147 may cause the subject vehicle M to enter between other vehicles m and follow a preceding vehicle. On the other hand, in a case in which the subject vehicle cannot join in this section C3, the branching control executer 147 causes the subject vehicle to execute lane change to the branching lane L4 while decelerating the subject vehicle M at a time point at which the distance D up to the branching point Pb is equal to or less than the second threshold D2. Accordingly, the subject vehicle M runs toward the branching lane L4 while decelerating (a section C4).

According to the vehicle control device of the second embodiment described above, in a case in which a plurality of other vehicles recognized by the recognizer 130 are aligned on a road shoulder recognized by the road shoulder recognizer 131 in the advancement direction of the subject vehicle M, the branching controller 141 executes control of operating the direction indicator 230 at a timing earlier than that in a case in which a plurality of other vehicles m are not aligned on the road shoulder in the advancement direction of the subject vehicle M. Accordingly, even in a case in which the road shoulder is congested with a plurality of other vehicles directed toward the branching lane, the direction indicator 230 can be turned on and off on a further front side than the branching point. Accordingly, a driver of a following vehicle of the subject vehicle M can predict that the subject vehicle M decelerates.

In a case in which the driver of the following vehicle does not desire limited running, the driver can execute lane change to the right side.

### Third Embodiment

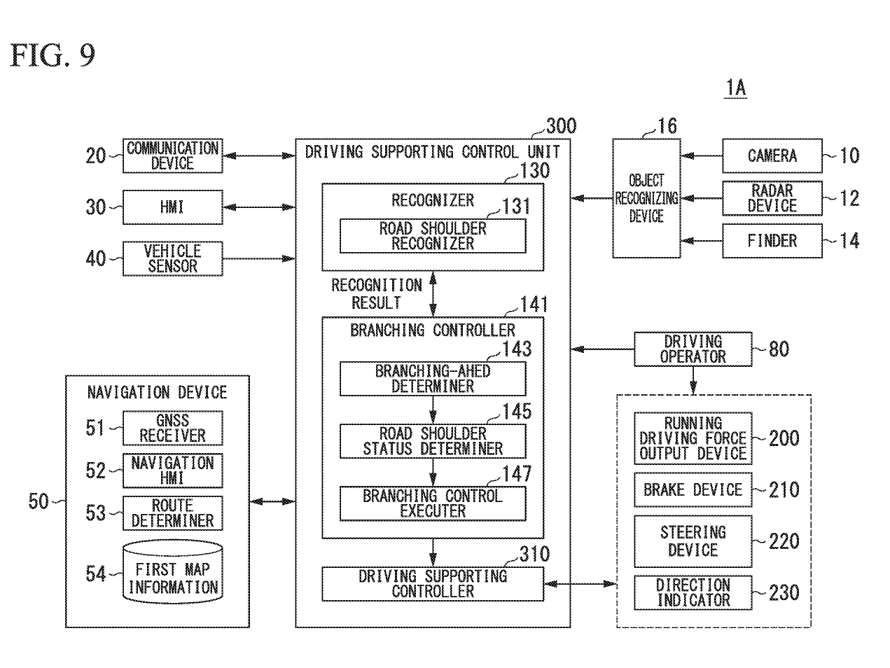

Hereinafter, an example in which a recognizer 130 and a branching controller 141 having the same functions and the same configurations as those of the first controller 120 described above are used in a vehicle having a driving supporting function will be described with reference to FIG. 9.

FIG. 9 is a configuration diagram of a vehicle system 1A in which a vehicle control device according to an embodiment is used in a vehicle having a driving supporting function. Functions and components that are similar to those of the vehicle system 1 will not be described here. The vehicle system 1A, for example, includes a driving supporting control unit 300 in which some of the components included in the vehicle system 1 are changed. The driving supporting control unit 300 includes a recognizer 130, a branching controller 141, and a driving supporting controller 310. The configuration illustrated in FIG. 9 is merely one example, and thus, a part of the configuration may be omitted, or another configuration may be further added.

The driving supporting controller 310, for example, has functions such as a lane keeping assist system (LKAS), an adaptive cruise control system (ACC), an auto lane change system (ALC), and the like.

A branching control executer 147 instructs a driving supporting controller 310 to turn a left direction indicator 230 to on and off. The driving supporting controller 310 turns the left direction indicator 230 on and off in accordance with the instruction. A branching control executer 147 executes the ALC and the LKAS such that a subject vehicle enters a branching lane. In a case in which the subject vehicle is caused to run the rear side of another vehicle running on a road shoulder or to run to follow the rear side of another vehicle entering a branching lane, the branching control executer 147 executes the ACC.

According to the vehicle control device of the third embodiment described above, effects similar to those of the first embodiment can be achieved.

### <Hardware Configuration>

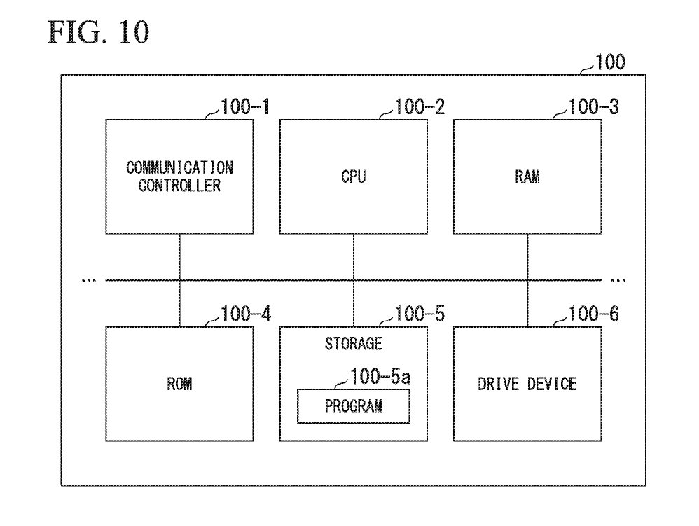

The vehicle control device according to the embodiment described above, for example, is realized by a hardware configuration as illustrated in FIG. 10. FIG. 10 is a diagram illustrating one example of the hardware configuration of a vehicle control device according to an embodiment.

The vehicle control device has a configuration in which a communication controller 100-1, a CPU 100-2, a RAM 100-3, a ROM 100-4, a secondary storage 100-5 such as a flash memory or an HDD, and a drive device 100-6 are interconnected through an internal bus or a dedicated communication line. A portable storage medium such as an optical disc is loaded into the drive device 100-6. A program 100-5a stored in the secondary storage 100-5 is expanded into the RAM 100-3 by a DMA controller (not illustrated in the drawing) or the like and is executed by the CPU 100-2, whereby the vehicle control device is realized. The program referred to by the CPU 100-2 may be stored in the portable storage medium loaded into the drive device 100-6 or may be downloaded from another device through a network NW.

The embodiment described above may be represented as below.

A vehicle control device is configured to include an imaging unit that images a front side and a rear side of a vehicle, a storage, and a hardware processor that executes a program stored in the storage.

The hardware processor, by executing the program, includes a first recognizer that recognizes other vehicles in the vicinity of a subject vehicle, a second recognizer that recognizes a road shoulder of a road on which the subject vehicle is present, and a controller that executes driving control of controlling one or both of steering and acceleration/deceleration of the subject vehicle.

The controller sets a degree of monitoring of other vehicles present on the road shoulder recognized by the second recognizer among other vehicles recognized by the first recognizer in a section disposed a predetermined distance before a branching point to be higher than a degree of monitoring of other vehicles present on the road shoulder in a section other than the section disposed the predetermined distance before the branching point.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, the road shoulder status determiner 145, in Step S105, may determine whether other vehicles m present on the road shoulder are moving (including slow moving) or continue to stop for a predetermined time or more and determine “Yes” in Step S105 in a case in which the other vehicles m are moving and determine “No” in Step S105 in a case in which the other vehicles continue to stop. For example, the road shoulder status determiner 145 derives speeds of the other vehicles m present on the road shoulder and determines a state of the other vehicles m on the basis of the derived running speeds. In such a case, the road shoulder status determiner 145 can perform appropriate control on the basis of congestion of vehicles advancing to the branching lane or vehicles brought onto the road shoulder due to an accident or the like. In other words, in the case of no congestion of vehicles m, which are present on the road shoulder, advancing to a branching lane, the direction indicator 23 disposed on the road shoulder side is not turned on and off. The subject vehicle M does not stop after a vehicle that continues to stop due to an accident or the like.

In Step S105, the road shoulder status determiner 145 may determine whether an object present on the road shoulder is a vehicle or an object (a sign board or the like) other than a vehicle and determine “Yes” in Step S105 in the case of a vehicle and determine “No” in Step S105 in the case of an object other than a vehicle. In such a case, the road shoulder status determiner 145 does not stop the subject vehicle M after an object such as a sign board due to erroneous determination of the object such as a sign board as congestion.

The conditions for executing the branching control may be changed in accordance with an actual congestion status near a branching point on a route of the subject vehicle M. For example, in a case in which traffic information representing that there is an actual congestion near a branching point on a route of the subject vehicle M is received from an external server using the communication device 20, the branching controller 141 may execute the branching control even in a case in which the subject vehicle is running ahead of the branching-ahead section. In the other hand, in a case in which traffic information representing no actual congestion is received, the branching controller 141 may not execute the branching control even within the branching-ahead section.

The branching controller 141 may select and execute one of the control according to the first embodiment and the control according to the second embodiment in accordance with an acquired road shoulder status. For example, the branching controller 141 may execute the control according to the first embodiment in a case in which the congestion of a vehicle present on the road shoulder is longer than a predetermined length and may execute the control according to the second embodiment in a case in which the congestion is shorter than the predetermined length. The control may be oppositely executed. The branching controller 141 can acquire a length of the congestion of a vehicle present on the road shoulder on the basis of a distance from a position of another vehicle present on the road shoulder to the branching point. The branching controller 141 may acquire a length of congestion of a vehicle present on the road shoulder on the basis of traffic information received from an external server.

What is claimed is:

1. A vehicle control device comprising:
a first recognizer recognizing, in the vicinity of a first vehicle, a plurality of second vehicles;
a second recognizer recognizing a road shoulder of a road on which the first vehicle is present; and
a controller executing driving control of controlling one or both of steering and acceleration/deceleration of the first vehicle,
wherein the controller sets a degree of monitoring of one of the plurality of second vehicles present on a road shoulder in a section from a branching point to a point a predetermined distance from the branching point, to be higher than another of the plurality of second vehicles present on a road shoulder out of the section.

2. The vehicle control device according to claim 1,
wherein, in a case in which the plurality of second vehicles are aligned in an advancement direction of the first vehicle on the road shoulder,
the controller executes control of causing the first vehicle to follow one of the plurality of second vehicles aligned on the road shoulder.

3. The vehicle control device according to claim 2, wherein the controller executes control of causing the first vehicle to follow a rearmost vehicle among the plurality of second vehicles aligned on the road shoulder.

4. The vehicle control device according to claim 1, wherein, in a case in which the plurality of second vehicles are aligned in an advancement direction of the first vehicle on the road shoulder, the controller executes control of operating a direction indicator at a timing earlier than that in a case in which the plurality of second vehicles are not aligned in the advancement direction of the first vehicle on the road shoulder.

5. The vehicle control device according to claim 2, wherein the controller determines a state of a first one of the plurality of second vehicles present on a road shoulder on the basis of a speed, executes the control in a case in which the state of the first one of the plurality of second vehicles are a moving state, and does not execute the control in a case in which the state of the first one of the plurality of second vehicles are a stopped state.

6. A vehicle control method executed by an in-vehicle computer mounted in a vehicle, the vehicle control method using the in-vehicle computer comprising:
recognizing, in the vicinity of a first vehicle, a plurality of second vehicles;
recognizing a road shoulder of a road on which the first vehicle is present;
executing driving control of controlling one or both of steering and acceleration/deceleration of the first vehicle; and
setting a degree of monitoring of one of the plurality of second vehicles present on a road shoulder in a section from a branching point to a point a predetermined distance from the branching point, to be higher than another of the plurality of second vehicles present on a road shoulder out of the section.

7. A computer-readable non-transitory storage medium having a program stored thereon, the program causing an in-vehicle computer to execute:
a process of recognizing, in the vicinity of a first vehicle, a plurality of second vehicles;
a process of recognizing a road shoulder of a road on which the first vehicle is present;
a process of executing driving control of controlling one or both of steering and acceleration/deceleration of the first vehicle; and
a process of setting a degree of monitoring of one of the plurality of second vehicles present on a road shoulder in a section from a branching point to a point a predetermined distance from the branching point, to be higher than another of the plurality of second vehicles present on a road shoulder out of the section.
